(19) United States
(12) Patent Application Publication
(10) Pub. No.: US 2025/0212234 A1
(43) Pub. Date: Jun. 26, 2025

(54) Audio multicasting method and device

(71) Applicant: Zgmicro Wuxi Corporation, Wuxi (CN)

(72) Inventor: Bin Xu, Wuxi (CN)

(21) Appl. No.: 19/000,673

(22) Filed: Dec. 23, 2024

(30) Foreign Application Priority Data
Dec. 25, 2023 (CN) 2023118016291

(51) Int. Cl. H04W 72/30; H04W 4/90

(52) U.S. Cl. CPC H04W 72/30; H04W 4/90

(57) ABSTRACT

An audio multicasting method and an audio multicasting device are described. In one embodiment, the method includes: broadcasting an audio packet based on a BIG link protocol; performing a periodic broadcast based on an advertising channel comprising a periodic advertising channel; and communicating bi-directionally with one or more slave devices on the periodic advertising channel based on a pre-configured bidirectional periodic advertising link protocol to allow one or more selected slave devices to group with the master device while performing the periodic broadcast, wherein the one or more selected slave devices are the slave devices that are allowed to receive the audio packet and extract playable audio data from the received audio packet. In this way, the audio multicasting method can realize audio multicasting function in an audio broadcast mode.

### CROSS-REFERENCE OF RELATED APPLICATIONS

The present invention claims priorities of Chinese Patent Application No. 2023118016291 filed in China on Dec. 25, 2023, the entire contents of which are incorporated herein by reference.

### BACKGROUND OF THE INVENTION

### Field of the Invention

The present invention relates to the field of wireless communication technology, and specifically relates to an audio multicasting method, and an audio multicasting device.

### Description of the Related Art

Bluetooth Low Energy (BLE) audio technology uses isochronous channels protocols, comprising a Connected Isochronous Stream (CIS) link for point-to-point communication, a Connected Isochronous Group (CIG) link composed of at least one CIS link, as well as a Broadcast Isochronous Stream (BIS) link for point-to-multipoint communication and a Broadcast Isochronous Group (BIG) link composed of at least one BIS link. The BLE audio technology brings lower power consumption, lower cost, lower latency, higher quality, and more abundant wireless audio services through these protocols. For example, an Audio Multicast Channel (AMC) function from point to limited multipoint is implemented by using multiple CIG links, and an Audio Broadcasting Channel (ABC) function from point to unlimited multipoint is implemented by using the BIG link protocol.

However, due to limitation of effective bandwidth, the number of slave devices that can be accessed simultaneously in the CIG link-based AMC is very small. The BIG link-based ABC, which can access an unlimited number of slave devices, cannot control the access of a limited number of slave devices. Therefore, it is difficult to be used to implement the audio multicasting function.

### SUMMARY OF THE INVENTION

In view of this, the present invention provides an audio multicasting method and an audio multicasting device to solve the problem that it is difficult to realize the audio multicasting function in an audio broadcast mode.

To achieve the purpose, according to one aspect of the present invention, an audio multicasting method applied to a master device is provided. The audio multicasting method comprises: broadcasting an audio packet based on a BIG link protocol; performing a periodic broadcast based on an advertising channel comprising a periodic advertising channel; and communicating bi-directionally with one or more slave devices on the periodic advertising channel based on a pre-configured bidirectional periodic advertising link protocol to allow one or more selected slave devices to group with the master device while performing the periodic broadcast, wherein the one or more selected slave devices are the slave devices that are allowed to receive the audio packet and extract playable audio data from the received audio packet.

According to another aspect of the present invention, an audio multicasting method applied to a slave device is provided. The audio multicasting method comprises: receiving a periodic broadcast from a master device based on an advertising channel comprising a periodic advertising channel; communicating bi-directionally with the master device on the periodic advertising channel based on a pre-configured bidirectional periodic advertising link protocol to be allowed by the master device to group with the master device as a selected slave device upon receiving the periodic broadcast; and receiving an audio packet broadcast by the master device based on a BIG link protocol and extracting playable audio data from the received audio packet in the case of grouping with the master device as the selected slave device.

According to another aspect of the present invention, an audio multicasting device applied to a master device is provided. The audio multicasting device comprises: an audio transmitting module for broadcasting an audio packet based on a BIG link protocol; a periodic broadcast module for performing a periodic broadcast based on an advertising channel comprising a periodic advertising channel; a first grouping module for communicating bi-directionally with one or more slave devices on the periodic advertising channel based on a pre-configured bidirectional periodic advertising link protocol to allow one or more selected slave devices to group with the master device while performing the periodic broadcast, wherein the one or more selected slave devices are the slave devices that are allowed to receive the audio packet and extract playable audio data from the received audio packet.

According to another aspect of the present invention, an audio multicasting device applied to a slave device is provided. The audio multicasting device comprises: a broadcast receiving module for receiving a periodic broadcast from a master device based on an advertising channel comprising a periodic advertising channel; a second grouping module for communicating bi-directionally with the master device on the periodic advertising channel based on a pre-configured bidirectional periodic advertising link protocol to be allowed by the master device to group with the master device as a selected slave device upon receiving the periodic broadcast; an audio receiving module for receiving an audio packet broadcast by the master device based on a BIG link protocol and extracting playable audio data from the received audio packet in the case of grouping with the master device as the selected slave device.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings wherein:

FIG. 1 is a schematic flow diagram of an audio multicasting method according to one embodiment of the present invention;

FIG. 2 is a schematic diagram of a public extended advertising payload format according to one embodiment of the present invention;

FIG. 3 is a schematic diagram of an extended header format according to one embodiment of the present invention;

FIG. 4 is a schematic diagram of an extended header flag bit according to one embodiment of the present invention;

FIG. 5 is a schematic diagram of the audio multicasting method implemented by a master device according to one embodiment of the present invention;

FIG. 6 is a schematic flow diagram of another audio multicasting method according to one embodiment of the present invention;

FIG. 7 is a schematic flow diagram of the audio multicasting method implemented by a slave device according to one embodiment of the present invention;

FIG. 8 is a block diagram of an audio multicasting system according to one embodiment of the present invention;

FIG. 9 is a block diagram of another audio multicasting system according to one embodiment of the present invention;

FIG. 10 is a structural schematic diagram of an AMC master speaker according to one embodiment of the present invention;

FIG. 11 is a structural schematic diagram of an AMC slave speaker according to one embodiment of the present invention;

FIG. 12 is a structural block diagram of an audio multicasting device according to one embodiment of the present invention;

FIG. 13 is a structural block diagram of another audio multicasting device according to one embodiment of the present invention; and

FIG. 14 is a schematic diagram of a hardware structure of a computer device according to one embodiment of the present invention.

### DETAILED DESCRIPTION OF THE PREFERRED EMBODIMENTS

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

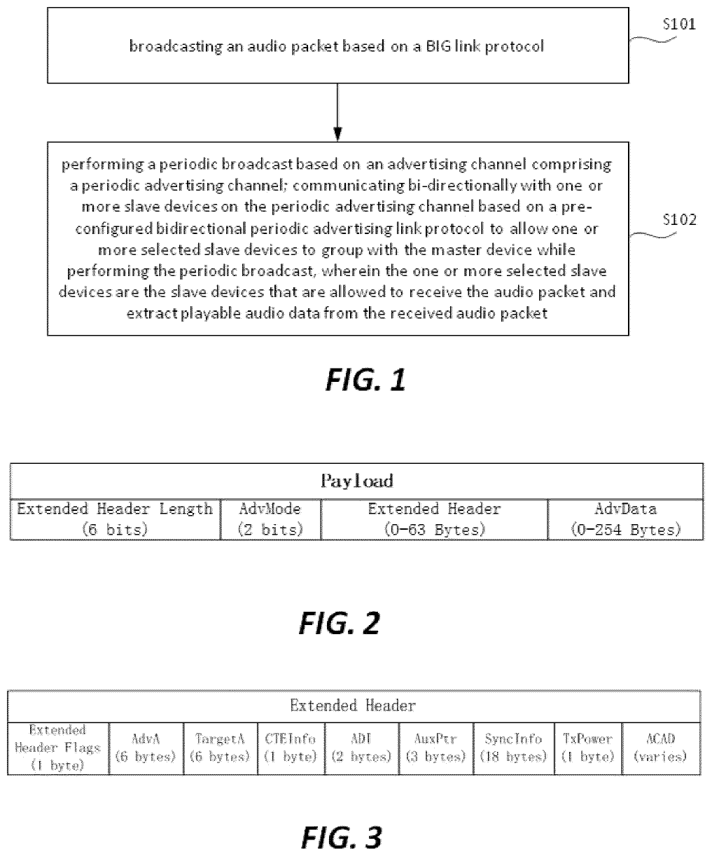

An audio multicasting method applied to a master device is provided according to one embodiment of the present invention. The master device may be an audio source device or a device capable of realizing audio playback, such as a speaker, a cell phone and other devices. FIG. 1 is a flowchart of the audio multicasting method applied to a master device according to one embodiment of the present invention. As shown in FIG. 1, the audio multicasting method comprises following operations.

At S101, the master device broadcasts an audio packet based on a BIG link protocol. Specifically, the audio packet may be transmitted on a broadcast isochronous stream (BIS) link, and may be carried by a BIS packet. When the master device establishes a BIS link, the master device transmits the audio data by transmitting a BIS PDU (Protocol Data Unit) on the BIS link.

It is to be understood that the BIG link protocol may be the existing BIG link protocol of the Bluetooth technical specification, or may be a BIG link protocol that is improved based on the existing BIG link protocol, or may be other similar standard or private protocols. At S102, the master device performs a periodic broadcast based on an advertising channel. The advertising channel comprises a periodic advertising channel based on the advertising channel.

The master device communicating bi-directionally with one or more slave devices on the periodic advertising channel based on a pre-configured bidirectional periodic advertising link protocol to allow one or more selected slave devices to group with the master device while the periodic broadcast is performed at S102. The one or more selected slave devices are the slave devices that are allowed to receive the audio packet and extract playable audio data from the received audio packet.

It is to be understood that the bidirectional periodic advertising link protocol is used to specify specific rules for bidirectional periodic advertising communication between the master device and the slave device, such as a data transmission interval, a transmission time starting point, a data format, etc. The advertising channel may comprise one or more channels specified in advance, which can be configured according to specific application scenarios. The master device can synchronize the slave devices with the master device and perform group negotiation for audio multicasting through the bidirectional periodic broadcasting.

In the existing BLE protocol, the BIG master device enables the BIG slave devices to scan and synchronize to the BIG master device with low power consumption by means of periodic broadcasting on the advertising channel. Specifically, the BIG slave device synchronizes with the BIG master device and obtains BIG link information (BIGInfo) through an extended advertising (ADV_EXT_IND) Protocol Data Unit (PDU) transmitted by the BIG master device on a primary advertising channel, an auxiliary advertising (AUX_ADV_IND) PDU transmitted by the BIG master device on a secondary advertising channel, and a synchronization (AUX_SYNC_IND) PDU transmitted by the BIG master device on a periodic advertising channel, so as to receive the audio data carried by the BIS PDU. In this mode, the access of an unlimited number of slave devices can be realized, but the access of a limited number of slave devices cannot be controlled, and the access of slave devices cannot be selectively allowed. This is not conducive to the realization of the audio multicasting function.

In one embodiment, a bidirectional communication between the master device and the slave device can be realized on the periodic advertising channel, so as to negotiate and control the access of selected slave devices and a limited number of slave devices, complete the grouping between the master and slave devices, and broadcast the audio packet through the BIG link protocol. Therefore, the audio multicasting function in the audio broadcasting mode can be realized in the present invention. In the audio multicasting method according to one embodiment, the number of access slave devices is controllable and not limited by bandwidth. Compared with the existing scheme, it has a wider application range. In some specific embodiments, the slave devices may be devices capable of realizing audio playback, such as speakers, headphones and other devices.

For selection of the slave device, the slave device may be selected by pre-set filtering rules or selection rules, or slave device information obtained in the bidirectional communication process may be displayed on a user interface, and the user can select the slave devices via the user interface. This embodiment does not make any specific limitation on the selection of the slave device. After the selected slave device finishes the grouping with the master device, it can correctly receive the BIS PDU and obtain the audio data therein.

An audio multicasting method applied to a master device according to one embodiment of the present invention is provided. The audio multicasting method comprises following operations. At S201, the master device broadcasts an audio packet based on a BIG link protocol. For details, please refer to S101 of the embodiment shown in FIG. 1, which will not be repeated here.

At S202, the master device performs a periodic broadcast based on an advertising channel. The advertising channel comprises a periodic advertising channel based on the advertising channel. The advertising channel is configured according to the BLE protocol. The advertising channel further comprises a primary advertising channel, and a secondary advertising channel. The periodic broadcast performed based on the advertising channel further comprises: transmitting an extended advertising protocol packet on the primary advertising channel, and transmitting an auxiliary advertising protocol packet on the secondary advertising channel for the slave device to synchronize and receive a search packet.

Specifically, since the advertising channel is configured based on the BLE protocol, thereby the primary advertising channel and the secondary advertising channel are the same as the channels in the BLE Audio protocol. That is, the extended advertising protocol packet transmitted on the primary advertising channel and the auxiliary advertising protocol packet transmitted on the secondary advertising channel have the same format and content as the packets transmitted on the primary advertising channel and the secondary advertising channel in the BLE protocol. No further details will be given here. It should be noted that the extended advertising protocol packet may be an extended advertising (ADV_EXT_IND) PDU, and the auxiliary advertising protocol packet transmitted on the secondary advertising channel may be an auxiliary advertising (AUX_ADV_IND) PDU.

The master device communicates bi-directionally with one or more slave devices on the periodic advertising channel based on a pre-configured bidirectional periodic advertising link protocol to allow one or more selected slave devices to group with the master device while the periodic broadcast is performed at S202. The one or more selected slave devices are the slave devices that are allowed to receive the audio packet and extract playable audio data from the received audio packet.

Specifically, the bidirectional communication with one or more slave devices on the periodic advertising channel based on a pre-configured bidirectional periodic advertising link protocol comprises following operations.

At S2021, a search packet is broadcasted on the periodic advertising channel. At S2022, a grouping request packet transmitted by one or more slave devices based on the search packet is received. Specifically, a time slot for transmitting the search packet is a time slot for transmitting a synchronous packet specified by the BLE protocol. A time slot for receiving the grouping request packet is a time slot which is after the time slot for transmitting the synchronous packet specified by the BLE protocol and is spaced by a predetermined inter-packet interval time length. That is, after the slave device receives the search packet, the slave device may transmit the grouping request packet after an interval of a predetermined time. The predetermined time is a Time of Inter Frame Space (T_IFS) between adjacent packets, for example, it can be 150 microseconds. The master device may continuously transmit the search packet on the periodic advertising channel until the grouping request packet is received. In addition, after receiving the grouping request packet, the master device can use a cyclic redundancy checksum (CRC) to check it and determine whether the grouping request packet is received correctly, that is, detect whether CRC check information carried in the grouping request packet is correct.

At S2023, a configuration packet is transmitted to the selected slave device based on a slave device information contained in the grouping request packet. The configuration packet comprises a configuration information for the selected slave device to receive the audio packet and extract the playable audio data from the received audio packet based on the configuration information.

Specifically, after the master device receives the grouping request packet, the master device may select a certain number of slave devices to join the multicast based on the slave device information contained in the grouping request packet, and transmit the configuration packet to the selected slave devices. After the slave device receives the configuration packet, the slave device may parse the configuration information contained in the configuration packet to obtain a BIG link information, so as to synchronize with the master device and obtain the playable audio data. It is to be noted that the selection of the slave devices may be performed according to a preset filtering rule or selection rule, or the information of the slave device in the obtained grouping request packet may be displayed on the user interface, and a user selects the slave device via the user interface. The selection method of the slave device is not specifically limited in the present invention.

At S2024, a response packet transmitted by the selected slave device according to the configuration packet is received to complete grouping with the selected slave device. Specifically, a time slot for transmitting the configuration packet is a time slot for transmitting the synchronous packet specified by the BLE protocol. A time slot for receiving the response packet is a time slot which is after the time slot for transmitting the synchronous packet specified by the BLE protocol and is spaced by a predetermined inter-packet interval time length. That is, after the slave device receives the configuration packet and confirms to join the multicast of the master slave, the slave device can reply with the response packet to the master device after an interval of predetermined time. Before receiving the response packet, the configuration packet can be continuously transmitted on the periodic advertising channel until the response packet is received. In addition, after the master device receives the response packet, the master device can also use the CRC check to determine whether it is received correctly.

It should be noted that the search packet may be transmitted in the form of a synchronous grouping search protocol data unit, the grouping request packet may be transmitted in the form of a synchronous grouping request protocol data unit, the configuration packet may be transmitted in the form of a synchronous grouping configuration protocol data unit, and the response packet may be transmitted in the form of a synchronous grouping response protocol data unit. The protocol data unit (PDU) is only one form of transmitting the packet, and may also be transmitted in other forms.

Specifically, the synchronous grouping search protocol data unit (SYNC_GROUP_SEARCH PDU), the synchronous grouping request protocol data unit (SYNC_GROUP_REQ PDU), the synchronous grouping configuration protocol data unit (SYNC_GROUP_CONFIG PDU), and the synchronous grouping Response Protocol Data Unit (SYNC_GROUP_RSP PDU) can be transmitted on the Periodic Advertising channel similar to the BLE Audio protocol. Therefore, SYNC_GROUP_SEARCH PDU, SYNC_GROUP_REQ PDU, SYNC_GROUP_CONFIG PDU, and SYNC_GROUP_RSP PDU are similar to the synchronous Protocol Data Unit (AUX_SYNC_IND PDU) that is transmitted on the Periodic Advertising channel in the BLE Audio protocol. All of them adopt a Common Extended Advertising Payload Format (CEPF) as shown in FIG. 2 of the BLE Audio specification.

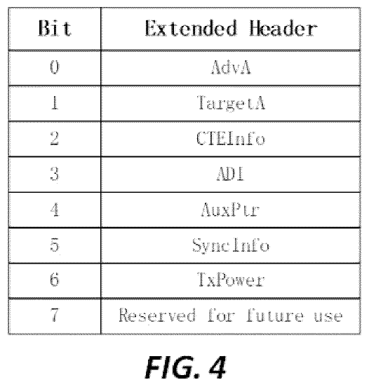

The Common Extended Advertising Payload Format contains an extended header length (Extended Header Length) of 6 bits, an advertising mode (AdvMode) of 2 bits, an extended header of 0-63 bytes, and an advertising data (AdvData) up to 254 bytes. The Extended Header format is shown in FIG. 3, and may comprise fields such as an Extended Header Flags field, an AdvA field, a TargetA field, a CTEInfo field, an ADI field, an AuxPtr field, a SyncInfo field, a TxPower field, and an ACAD field, etc. The Extended Header Flags field comprises a plurality of extended header flag bits. As shown in FIG. 4, each bit corresponds to a field of the extended header, setting a certain bit to 1 indicates that the corresponding field exists in the extended header, and setting a certain bit to 0 indicates that the corresponding field does not exist in the extended header. The AdvA field represents the device address of the transmitting device. The TargetA field represents the device address of the target device. The CTEInfo field represents constant tone extension (CTE) information. The ADI field represents advertising data information. The AuxPtr field represents an auxiliary advertising pointer. The SyncInfo field represents synchronization information. The TxPower field represents transmission power, and the ACAD field represents Additional Controller Advertising Data. The AUX_SYNC_IND PDU carries the BIG link information (BIGInfo) through the ACAD field.

SYNC_GROUP_SEARCH PDU, SYNC_GROUP_REQ PDU, SYNC_GROUP_CONFIG PDU, and SYNC_GROUP_RSP PDU differ from AUX_SYNC_IND PDU in the content of the Extended Header and the AdvMode. The difference between SYNC_GROUP_SEARCH PDU and AUX_SYNC_IND PDU is that bit0 of the Extended Header Flags bits of SYNC_GROUP_SEARCH PDU is set to 1, which indicates that its Extended Header contains the AdvA field. The AdvA field represents the device address of the master device. The other fields of SYNC_GROUP_SEARCH PDU are the same as those of AUX_SYNC_IND PDU, and both contain the BIGInfo in the ACAD field. The AdvMode is set to 0b01, which indicates undirected grouping available. SYNC_GROUP_SEARCH PDU is similar to AUX_SYNC_IND PDU in providing the BIGInfo to the slave device and is also used by the master device to search for surrounding slave devices.

The difference between SYNC_GROUP_REQ PDU and AUX_SYNC_IND PDU is that the bit0 and bit1 of the Extended Header Flags bits of SYNC_GROUP_REQ PDU are set to 1, which indicates that its Extended Header contains the AdvA field and the TargetA field. The AdvA field represents the device address of the slave device and the TargetA field is the device address of the master device. However, the ACAD field of SYNC_GROUP_REQ PDU does not contain the BIGInfo, and the other fields of SYNC_GROUP_REQ PDU are the same as those of AUX_SYNC_IND PDU. The AdvMode is set to 0b11, which indicates Grouping Request. The AdvData of the SYNC_GROUP_REQ PDU can carry information such as a device name or a device Universally Unique Identifier (UUID). SYNC_GROUP_REQ PDU is configured for the slave device to request the master device to allow it to join the multicast.

The difference between SYNC_GROUP_CONFIG PDU and AUX_SYNC_IND PDU is that bit0 and bit1 of the Extended Header Flags bits of SYNC_GROUP_CONFIG PDU are set to 1, which indicates that its extended header contains the AdvA field and the TargetA field. The AdvA field represents the device address of the master device and the TargetA is the device address of the slave device. The other fields of SYNC_GROUP_CONFIG PDU are the same as those of AUX_SYNC_IND PDU, and all of them contain the BIGInfo in the ACAD field. The AdvMode is set to 0b10, which indicates Directed Grouping available. The SYNC_GROUP_CONFIG PDU is similar to the AUX_SYNC_IND PDU for providing the slave device with the BIGInfo, and is also configured for the master device to configure the information for joining the multicast for the slave device with the determined address. The grouping configuration information carried in the AdvData of the SYNC_GROUP_CONFIG PDU may comprise a scrambling code of Access Address of BIS PDU and/or a broadcast code. The length of the scrambling code of the Access Address is the same as that of the Access Address, and is configured for scrambling the Access Address generated by the BIS PDU according to the Seed Access Address parameter in the BIGInfo. That is, an actual access address used by the BIS PDU is obtained by performing an XOR operation on the access address generated according to the Seed Access Address parameter in the BIGInfo and the scrambling code by bits. Only the slave devices that are allowed to join the multicast can obtain the scrambling code of the access address, thereby restricting the slave devices that do not join the multicast from receiving the BIS PDU broadcast by the master device. When the master device encrypts the payload data of BIS PDU, the broadcast code is a parameter required for the slave device to decrypt the payload data of BIS PDU. Only the slave device that is allowed to join the multicast can obtain the broadcast code to decrypt the payload of the BIS PDU, thereby restricting the slave devices that do not join the multicast from decrypting the BIS PDU broadcast by the master device to obtain the audio data. It will be appreciated that either, or both, of configuring the access address scrambling code and the broadcast code may be employed, and other schemes may be employed that may be used to restrict the slave devices that do not join the multicast from receiving the audio packet, or to extract the playable audio data from the received audio packet.

The difference between SYNC_GROUP_RSP PDU and AUX_SYNC_IND PDU is that bit0 and bit1 of the Extended Header Flags bits of the SYNC_GROUP_RSP PDU are set to 1, which indicates that its extended header contains the AdvA field and the TargetA field. The AdvA field represents the device address of the slave device. The TargetA field represents the device address of the master device. However, the ACAD field of the SYNC_GROUP_RSP PDU does not contain the BIGInfo, and the other fields of the SYNC_GROUP_RSP PDU are the same as those of the AUX_SYNC_IND PDU. The AdvMode is set to 0b00, which indicates grouping response. The SYNC_GROUP_RSP PDU is configured for the slave device to respond to the grouping configuration of the master device and confirm joining the multicast.

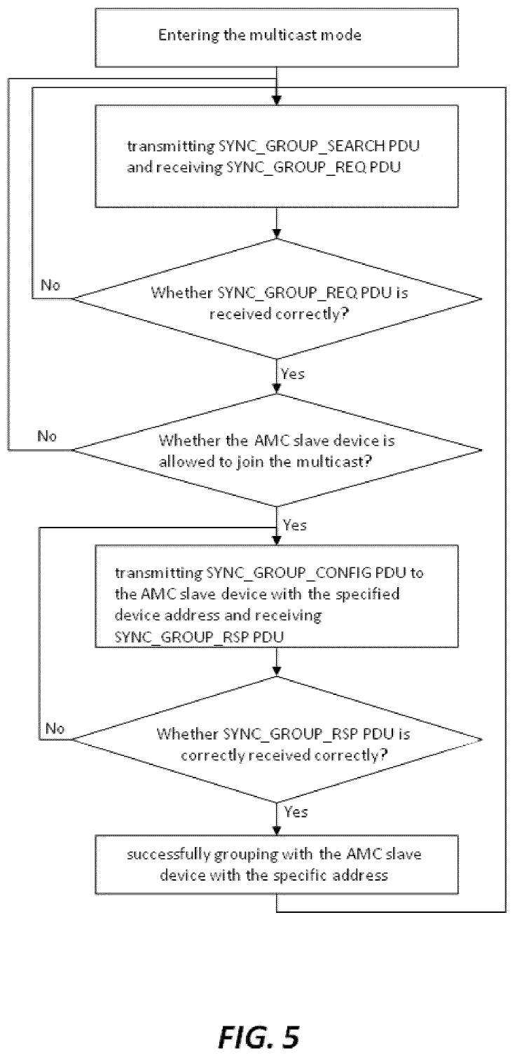

In this embodiment, the link between the master device and the slave device interacting with SYNC_GROUP_SEARCH PDU, SYNC_GROUP_REQ PDU, SYNC_GROUP_CONFIG PDU, and SYNC_GROUP_ RSP PDU may be referred to as a bidirectional periodic advertising (BPA) link. As a specific application embodiment of the present invention, the master device is an AMC (Audio Multicast Channel) master device, and the slave device is an AMC slave device. As shown in FIG. 5, the audio multicasting method is realized using the following process.

After the AMC master device enters the multicasting mode, it first transmits the SYNC_GROUP_SEARCH PDU and receives the SYNC_GROUP_REQ PDU. If the AMC master device does not correctly receive the SYNC_GROUP_REQ PDU, the AMC master device continues to transmit the SYNC_GROUP_SEARCH PDU and receive the SYNC_GROUP_REQ PDU. If the SYNC_GROUP_REQ PDU is correctly received and the AMC slave device with the specified device address is allowed to join the multicast, the AMC master device transmits the SYNC_GROUP_CONFIG PDU to the AMC slave device with the specified device address and receives the SYNC_GROUP_RSP PDU. Otherwise, the AMC master device continues to transmit the SYNC_GROUP_SEARCH PDU to search for the AMC slave device. If the SYNC_GROUP_RSP PDU is correctly received, the AMC master device groups with the AMC slave device with the specific device address successfully. Otherwise, the AMC master device continues to transmit the SYNC_GROUP_CONFIG PDU until the SYNC_GROUP_RSP PDU is correctly received or the timeout ends. After the AMC master device successfully groups with the AMC slave device with the specific device address, the AMC master device continues to transmit the SYNC_GROUP_SEARCH PDU to search for other AMC slave devices and repeat the above AMC slave device grouping process.

An audio multicasting method applied to the slave device is provided according to one embodiment of the present invention. The audio multicasting method comprises the following operations. At S301, the slave device receives a periodic broadcast from the master device based on an advertising channel. The advertising channel comprising a periodic advertising channel.

At S302, the slave device bi-directionally communicates with the master device on the periodic advertising channel based on a pre-configured bidirectional periodic advertising link protocol to be allowed by the master device to group with the master device as a selected slave device upon receiving the periodic broadcast. At S303, the slave device receives an audio packet broadcast by the master device based on a BIG link protocol and extracts playable audio data from the received audio packet in the case of grouping with the master device as the selected slave device.

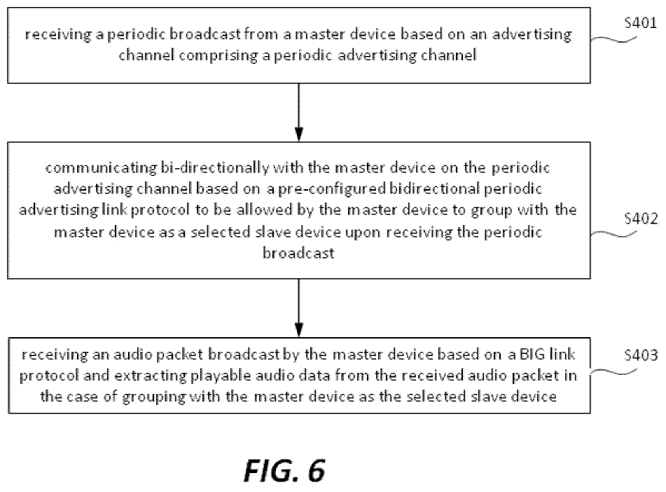

The more detailed functional descriptions of the above operations are the same as those of the corresponding master device as mentioned above, and will not be repeated here. An audio multicasting method applied to the slave device is provided according to one embodiment. As shown in FIG. 6, the method comprises the following operations. At S401, the slave device receives a periodic broadcast from the master device based on an advertising channel. The advertising channel comprising a periodic advertising channel. Specifically, the advertising channel is configured according to the BLE protocol. The advertising channel also comprises a primary advertising channel, a secondary advertising channel. Further, when the slave device receives the periodic broadcast from the master device, the slave device is specifically configured for: searching for an extended advertising packet transmitted by the master device on the primary advertising channel, receiving an auxiliary advertising packet transmitted by the master device on the secondary advertising channel based on the extended advertising packet, synchronizing and receiving the search packet based on the auxiliary advertising packet, thereby synchronizing with the master device.

Specifically, the slave device may enter the multicasting mode by means of user control in the user interface. When the slave device enters the multicasting mode, it needs to synchronize with the master device first, i.e., the slave device first searches for the extended advertising packet transmitted by the master device on the primary advertising channel, then receives the auxiliary advertising packet transmitted by the master device on the secondary advertising channel, and the search packet transmitted on the periodic advertising channel.

At S402, the slave device communicates bi-directionally with the master device on the periodic advertising channel based on a pre-configured bidirectional periodic advertising link protocol to be allowed by the master device to group with the master device as a selected slave device upon receiving the periodic broadcast. Specifically, the operation S402 comprises the following operations.

At S4021, the slave devise receives a search packet transmitted by the master device on the periodic advertising channel. Specifically, the search packet, together with the extended advertising packet and the auxiliary advertising packet, realizes the synchronization of the slave device and the master device. When the master device and the slave device are synchronized, then the slave device can obtain the BIG link information and receive the audio data carried by the BIS PDU.

At S4022, the slave device transmits a grouping request packet to the master device based on the search packet. Specifically, the slave device determines a predetermined number of search packets are received before transmitting the grouping request packet, and transmits the grouping request packet to the master device when the predetermined number of search packets is received.

After the slave device is synchronized to the master device, in order to avoid mutual interference by a plurality of slave devices simultaneously transmitting the grouping request packet, after a plurality of periodic advertising intervals are randomly delayed and the search packet is received again, the grouping request packet is transmitted after the interval of T_IFS. The periodic advertising interval is an interval for transmitting the search packet, or the master device transmits the search packet once every periodic advertising interval. Each time the master device transmits one search packet, the slave device can receive one search packet. After a plurality of periodic advertising intervals are reached, that is, after a plurality of search packets are received, the slave device may transmit the grouping request packet after the interval of T_IFS after receiving the last search packet.

At S4023, the slave device receives a configuration packet transmitted by the master device. The configuration packet comprises a configuration information for the selected slave device to receive the audio packet and extract the playable audio data from the received audio packet based on the configuration information. At S4024, the slave device transmits a response packet to the master device to complete the grouping with the master device as the selected slave device when the configuration packet is correctly received. For details, please refer to the operations S2023 and S2024 of the above embodiment, which will not be repeated herein.

At S403, the slave device receives an audio packet broadcast by the master device based on a BIG link protocol and extracts playable audio data from the received audio packet in the case of grouping with the master device as the selected slave device. Specifically, the configuration information comprises an access address scrambling code and/or a broadcast code.

The operation S403 specifically comprises: obtaining the access address scrambling code and/or the broadcast code in the configuration information at S4031; obtaining an access address of the audio packet broadcast by the master device based on the access address scrambling code, and receiving the audio packet based on the access address at S4032; and/or, decrypting the received audio packet using the broadcast code to obtain the playable audio data at S4033.

Specifically, the configuration information in the configuration packet transmitted by the master device comprises a scrambling code of the access address (Access Address) of the BIS PDU and/or a broadcast code. When the actual access address used by the BIS PDU is obtained by performing an XOR operation on the access address generated according to the Seed Access Address parameter in the BIGInfo and the scrambling code by bits, the configuration information comprises the scrambling code. The slave device can extract the scrambling code from the configuration information after the slave device receives the configuration information, and obtain the actual access address of the audio packet based on the scrambling code, so that the audio packet can be received. When the information carried in the BIS PDU is encrypted data, the configuration information comprises the broadcast code which is a parameter for decrypting the encrypted data. Therefore, after the slave device obtains the broadcast code based on the configuration information, the slave device decrypts the encrypted data according to the BLE protocol using the broadcast code to obtain the audio data.

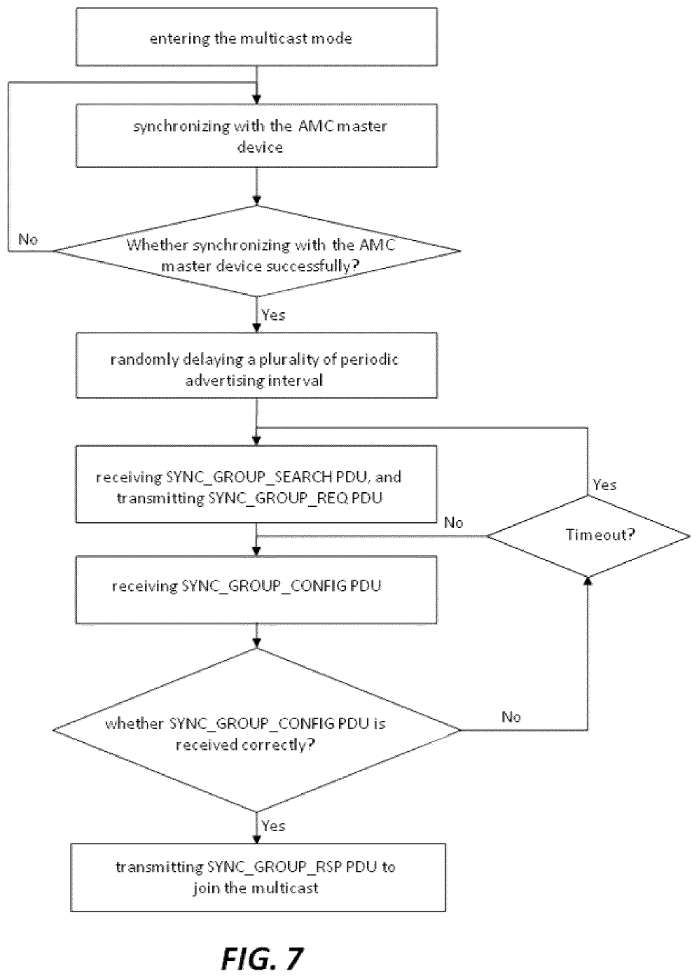

As a specific application embodiment of the present invention, the extended advertising packet can be transmitted in the form of the extended advertising protocol data unit (ADV_EXT_IND PDU), the auxiliary advertising packet can be transmitted in the form of the auxiliary advertising protocol data unit (AUX_ADV_IND PDU), the search packet can be transmitted in the form of the synchronous grouping search protocol data unit (SYNC_GROUP_SEARCH PDU), the grouping request packet can be transmitted in the form of the synchronous grouping request protocol data unit (SYNC_GROUP_REQ PDU), the configuration packet can be transmitted in the form of the synchronous grouping configuration protocol data unit (SYNC_GROUP_CONFIG PDU), the response packet can be transmitted in the form of the synchronous grouping response protocol data unit (SYNC_GROUP_REQ PDU). The master device is the AMC master device and the slave device is the AMC slave device. As shown in FIG. 7, the audio multicasting method is realized using the following operations.

After the AMC slave device enters the multicasting mode, the AMC slave device first synchronizes to the AMC master device, i.e., the AMC slave device first searches for the ADV_EXT_IND PDU transmitted by the AMC master device on the primary advertising channel, then receives the AUX_ADV_IND PDU transmitted by the AMC master device on the secondary advertising channel, and then receives the SYNC_GROUP_SEARCH PDU transmitted by the AMC master device on the periodic advertising channel to synchronize with the AMC master device. After the AMC slave device is synchronized with the AMC master device, in order to avoid mutual interference caused by multiple AMC slave devices simultaneously transmitting the SYNC_GROUP_REQ PDUs, after the AMC slave device randomly delays a plurality of periodic advertising intervals and receives the SYNC_GROUP_SEARCH PDU again, the AMC slave device transmits the SYNC_GROUP_REQ PDU after an interval of T_IFS. Then, the AMC slave device receives the SYNC_GROUP_CONFIG PDU transmitted by the AMC master device. If the SYNC_GROUP_CONFIG PDU is correctly received, the AMC slave device reply with the SYNC_GROUP_RSP PDU after an interval of T_IFS to confirm that the grouping is completed. Otherwise, the AMC slave device continuously receives the SYNC_GROUP_CONFIG PDU until a timeout occurs. After the timeout, the AMC slave device receives the SYNC_GROUP_SEARCH PDU again and transmits the SYNC_GROUP_REQ PDU. The process is repeated until the grouping is formed.

An audio multicasting system is provided according to one embodiment of the present invention. The audio multicasting system comprises a master device and at least one slave device. The master device broadcasts an audio packet based on a BIG link protocol. The master device performs a periodical broadcast based on an advertising channel. The advertising channel comprises a periodical advertising channel. The master device bi-directionally communicates with the slave device in accordance with the pre-configured bidirectional periodical advertising link protocol on the periodical advertising channel to allow one selected slave device to group with the master device. The slave device receives the audio packet broadcast by the master device based on a BIG link protocol and extracts playable audio data from the received audio packet in the case of grouping with the master device as the selected slave device.

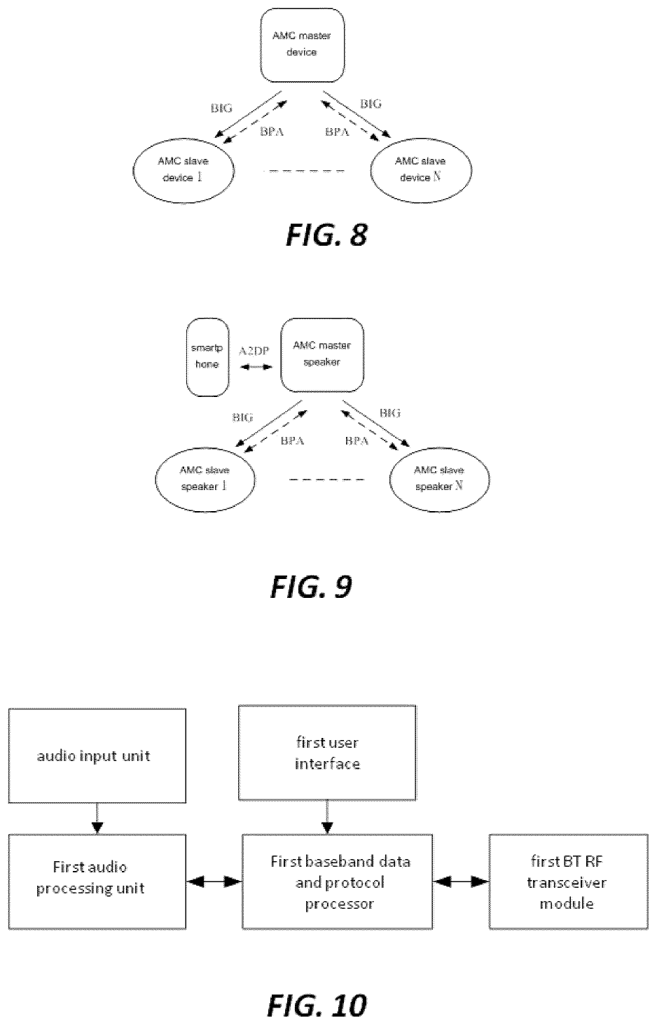

As shown in FIG. 8, the master device may also be referred to as an AMC master device and the slave device may also be referred to as an AMC slave device. The audio multicasting system comprises an AMC master device and at least one or more AMC slave devices, and N is greater than or equal to 1. The audio data is transmitted between the AMC master device and the ACM slave devices via the BIG link protocol, and the link information such as grouping search, grouping request, grouping configuration, and grouping response is transmitted via the bidirectional periodic advertising (BPA) link protocol.

Specifically, after the AMC master device automatically enters the multicasting mode or through user interface control, the AMC master device replaces the AUX_SYNC_IND PDU with the SYNC_GROUP_SEARCH PDU on the periodic advertising channel. After receiving the SYNC_GROUP_SEARCH PDU, the AMC slave device that wants to join the multicast of the AMC master device replies with the SYNC_GROUP_REQ PDU after an interval of T_IFS to request to join the multicast. T_IFS is the Time of Inter Frame Space (TIFS), and is equal to 150 us according to the BLE protocol. After the AMC master device receives the SYNC_GROUP_REQ PDU transmitted by the AMC slave device, the AMC master device confirms according to its device address, device name or unique device identifier to allow the AMC slave device to join the multicast through the user interface. Then, the AMC master device transmits the SYNC_GROUP_CONFIG PDU to the AMC slave device with corresponding device address and provides the scrambling code of the access address or the broadcast code for decryption, thus allowing the AMC slave device to receive or decrypt the audio data transmitted by the AMC master device. After the AMC slave device receives the SYNC_GROUP_CONFIG PDU transmitted by the AMC master device, the AMC slave device immediately transmits the SYNC_GROUP_RSP PDU after the interval of T_IFS to confirm joining the multicast. If the AMC master device does not receive the SYNC_GROUP_RSP PDU from the AMC slave device, the AMC master device needs to resend the SYNC_GROUP_CONFIG PDU until it correctly receives the SYNC_GROUP_RSP PDU transmitted by the AMC slave device.

After the AMC slave device is synchronized with the AMC master device, in order to avoid mutual interference caused by multiple AMC slave devices simultaneously transmitting the SYNC_GROUP_REQ PDUs, after the AMC slave device randomly delays a plurality of periodic advertising intervals and receives the SYNC_GROUP_SEARCH PDU again, and the AMC slave device transmits the SYNC_GROUP_REQ PDU after the interval of T_IFS.

As a specific application embodiment of the present invention, the structure as well as the working principle of the audio multicasting system using an A2DP audio source is illustrated as an example. As shown in FIG. 9, the audio multicasting system comprises a smartphone, an AMC master speaker, and at least one or more AMC slave speakers. The AMC master speaker is the AMC master device, and the AMC slave speakers are the AMC slave devices. The AMC master speaker obtains an Advanced Audio Distribution Profile (A2DP) audio source provided by the smartphone via a Classic BT link. The AMC master speaker and the AMC slave speakers transmit the audio data via the BIG link, and transmit and receive SYNC_GROUP_SEARCH PDU, SYNC_GROUP_REQ PDU, SYNC_GROUP_CONFIG PDU, SYNC_GROUP_RSP PDU via the BPA link to realize the multicasting function. The Classic BT link of the AMC master speaker coexists with the BIG and BPA links in a time-division multiplexing mode. The AMC master speaker receives the A2DP audio from the smartphone via the Classic BT link and then multicasts it to the AMC slave devices through the BIG link. Compared with the BIG-based Audio Broadcasting (ABC), the present invention uses the BPA link to control the AMC slave speakers to form a group before they can normally receive and play the audio streaming broadcast by the AMC master speaker, thereby realizing the audio multicasting function joined by a controlled limited number of AMC slave speakers.

The audio multicasting system works as follows: when any AMC speaker connects to the smartphone via the Classic BT link and turns on the A2DP wireless audio source, it automatically works as the AMC master speaker, and other AMC speakers that do not turn on the A2DP audio source automatically works as the AMC slave speakers. After he AMC master speaker receives the audio from the A2DP audio source, the AMC master speaker decodes the audio first, and then encodes it using the Low Complexity Communication Codec (LC3) of the BLE Audio technology and caches it. After caching to a certain amount, the encoded audio data will be played locally through the LC3 decoding on one hand, and then be transmitted to the AMC slave speaker through the BIG link for decoding and being played synchronously. The main parameters of the BIG link established by the BIG master speaker comprise, an isochronous interval of 20 ms, a BIS number of 2, a number of sub-events (NSE: Number of Sub-Events) equal to 6, a number of bursts (BN: Burst Number) equal to 2, a number of immediate retransmission counts (IRC: Immediate Repetition Count) equal to 3, and a pre-transmission offset (PTO: Pre-Transmission Offset) equal to 0. Transmission Offset (PTO: Pre-Transmission Offset) value is equal to 0. BLE 2 Mbps physical layer transmission is used.

After the AMC master speaker enters the multicasting mode through the user interface or automatically, the AMC master speaker transmits the SYNC_GROUP_SEARCH PDU on the Periodic Advertising channel to transmit the BIG Info. After the AMC slave speaker synchronizes with the AMC master speaker and the AMC slave speaker receives the SYNC_GROUP_SEARCH PDU, the AMC slave speaker can transmit the SYNC_GROUP_REQ PDU after an interval of T_IFS to request to join the multicast. The AMC master speaker collects the information (comprising device name or UUID in AdvData, etc.) of the AMC slave speaker that transmits the SYNC_GROUP_REQ PDU, and then presents it to the user through the user interface. For example, the AMC master speaker can display the collected information of the AMC slave speaker to the user through the user interface of the wirelessly connected smartphone. The user can click on the identifier of the specific AMC slave speaker through the user interface to allow it to join the multicast, or drag the identifier of the AMC slave speaker into the multicast. Then, the AMC master speaker transmits the SYNC_GROUP_CONFIG PDU to the AMC slave speakers allowed to join the multicast respectively on the periodic advertising channel to provide the scrambling code or the broadcast code to facilitate the AMC slave speaker to receive or decrypt the audio streaming transmitted by the AMC master speaker. After the AMC slave speaker receives the SYNC_GROUP_CONFIG PDU, it replies with the SYNC_GROUP_RSP PDU after the interval of T_IF to confirm joining the multicast and complete the group formation.

The AMC master speaker and the AMC slave speakers joined in the multicast can remember or save the grouping information from each other. For example, the AMC master speaker saves the device addresses and related information of all AMC slave devices that have joined the multicast, and the AMC slave device saves the device address of the ACM master speaker and the previously obtained scrambling code or the broadcast code. After the AMC device that has saved the grouping information is restarted, it automatically enters the multicast. If the AMC master speaker needs to update the scrambling code or the broadcast code after being restarted, it can sequentially transmit the SYNC_GROUP_CONFIG PDU according to the device addresses of the AMC slave speakers in the saved grouping information to provide a new scrambling code or broadcast code.

As shown in FIG. 10, the AMC master speaker comprises an audio input unit, a first user interface, a first audio processing unit, a first baseband data and protocol processor, and a first BT (Bluetooth) radio frequency (RF) transceiver module. The audio input unit can be a module that wirelessly receives the A2DP audio source. The audio input unit obtains the digital audio signal and transmits it to the first audio processing unit. After receiving the digital audio signal, the first audio processing unit first decodes it and then compresses and encodes it into audio data using LC3. The first baseband data and protocol processor executes the BIG and BPA protocols related to the BLE Audio technology and processes the audio data into BIS PDUs suitable for transmission by the first BT radio frequency transceiver module. The first BT radio frequency transceiver module is configured for transmitting and receiving BT wireless signal or various PDU, comprising transmitting and receiving the PDUs related to BPA. The first user interface can be buttons, a touch screen, a wireless control interface, etc., and is used to obtain instructions for controlling the multicasting function.

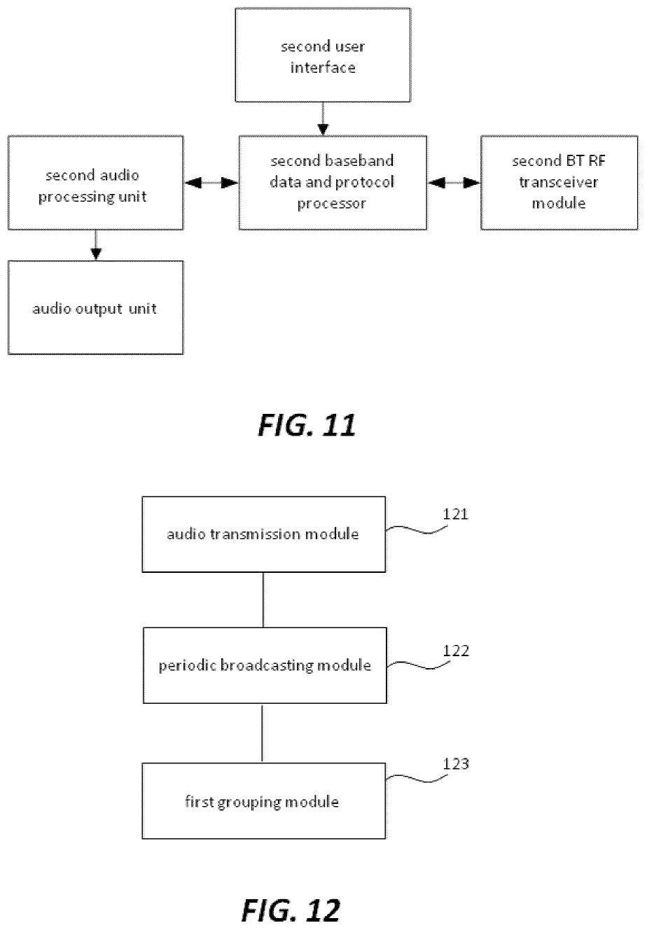

As shown in FIG. 11, the AMC slave speaker comprises a second user interface, an audio output unit, a second audio processing unit, a second baseband data and protocol processor, and a second BT radio frequency transceiver module. The second baseband data and protocol processor executes the BIG and BPA protocols related to the BLE Audio technology, processes the BIS PDUs transmitted by the AMC master speaker received by the second BT radio frequency transceiver module, and transmits them to the second audio processing unit. The second audio processing unit is configured for post-processing such as audio decoding, packet loss processing, equalization, and sound effects. The audio output unit is used to convert audio signals into sound signals. The second BT radio frequency transceiver module is configured for transmitting and receiving BT wireless signal or various PDUs, comprising transmitting and receiving the PDUs related to BPA. The second user interface can be buttons, a touch screen, a wireless control interface, etc., and is used to obtain instructions for controlling the multicasting function.

In one embodiment, an audio multicasting device is also provided. The audio multicasting device is used to implement the above embodiments and preferred embodiment, and the description that has been made will not be repeated. As used hereinafter, the term “module” can be a combination of software and/or hardware that realizes a predetermined function. Although the device described in the following embodiments is preferably implemented in software, implementation in hardware or a combination of software and hardware is also possible and contemplated.

An audio multicasting device applied to the master device is provided according to one embodiment of the present invention. As shown in FIG. 12, the audio multicasting device comprises an audio transmission module 121 configured for broadcasting audio packets based on the BIG link protocol; a periodic broadcasting module 122 configured for periodic broadcasting based on the advertising channel comprising a periodic advertising channel; a first grouping module 123 configured for communicating bi-directionally with one or more slave devices on the periodic advertising channel based on a pre-configured bidirectional periodic advertising link protocol to allow one or more selected slave devices to group with the master device while performing the periodic broadcast, so as to allow the selected slave device to group with the master device. The one or more selected slave devices are the slave devices that are allowed to receive the audio packet and extract the playable audio data from the received audio packet.

In one embodiment, the first grouping module is specifically configured for: broadcasting a search packet on the periodic advertising channel; receiving a grouping request packet transmitted by one or more slave devices based on the search packet; transmitting a configuration packet to the one or more selected slave devices based on a slave device information contained in the grouping request packet; receiving a response packet transmitted by the one or more selected slave devices based on the configuration packet to complete grouping with the selected slave device. The configuration packet comprising a configuration information for the one or more selected slave devices to receive the audio packet and extract the playable audio data from the received audio packet based on the configuration information.

In one embodiment, the search packet carries a BIG link information and a master device address; the grouping request packet carries the master device address, a slave device address and a device identity information; the configuration packet carries the master device address, the selected slave device address, the BIG link information and a grouping configuration information; the response packet carries the master device address and the slave device address. A time slot for transmitting the search packet and the configuration packet is a time slot for transmitting a synchronous packet specified by a BLE protocol. A time slot for receiving the grouping request packet and the response packet is a time slot which is after the time slot for transmitting the synchronous packet specified by the BLE protocol and is spaced by a predetermined inter-packet interval time length.

In one embodiment, the advertising channel is configured according to the BLE protocol. The advertising channel also comprises: a primary advertising channel and a secondary advertising channel. The periodic broadcasting module is specifically configured for: transmitting an extended advertising protocol packet on the primary advertising channel, and transmitting an auxiliary advertising protocol packet on the secondary advertising channel for the slave device to synchronize and receive the search packet.

The more detailed function descriptions of the above various modules and units are the same as those of the corresponding embodiments above and will not be repeated here. In one embodiment, an audio multicasting device is also provided. The audio multicasting device is used to implement the above embodiments and preferred embodiment, and the description that has been made will not be repeated. As used hereinafter, the term “module” can be a combination of software and/or hardware that realizes a predetermined function. Although the device described in the following embodiments is preferably implemented in software, implementation in hardware or a combination of software and hardware is also possible and contemplated.

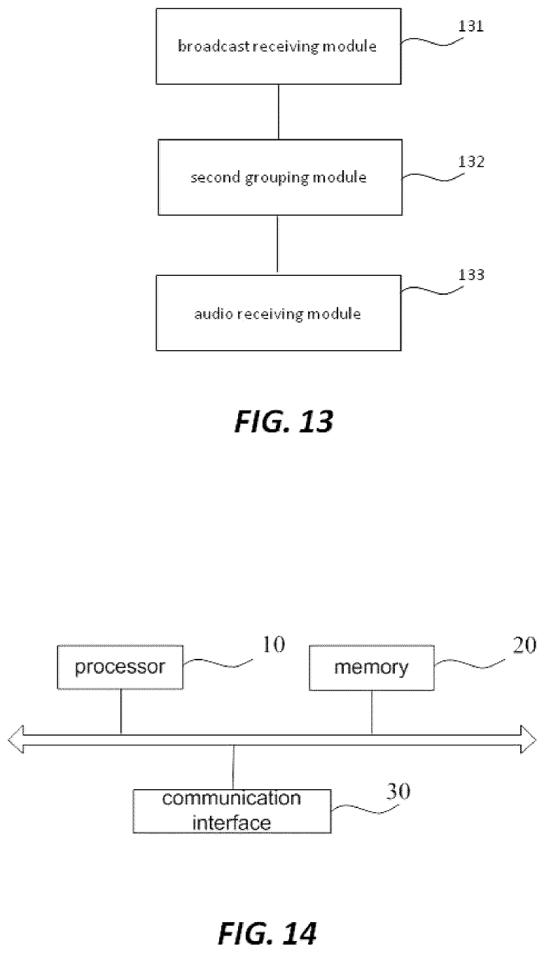

An audio multicasting device applied to the slave device is provided according to one embodiment of the present invention. As shown in FIG. 13, the audio multicasting device comprises: a broadcast receiving module 131 configured for receiving a periodic broadcast from a master device based on an advertising channel comprising a periodic advertising channel; a second grouping module 132 configured for communicating bi-directionally with the master device on the periodic advertising channel based on a pre-configured bidirectional periodic advertising link protocol to be allowed by the master device to group with the master device as a selected slave device upon receiving the periodic broadcast; and an audio receiving module 133 configured for receiving an audio packet broadcast by the master device based on a BIG link protocol and extracting playable audio data from the received audio packet in the case of grouping with the master device as the selected slave device.

In one embodiment, the second grouping module is specifically configured for: receiving a search packet transmitted by the master device on the periodic advertising channel; transmitting a grouping request packet to the master device based on the search packet; receiving a configuration packet transmitted by the master device, the configuration packet comprising a configuration information for the selected slave device to receive the audio packet and extract the playable audio data from the received audio packet based on the configuration information; and transmitting a response packet to the master device to complete the grouping with the master device as the selected slave device when the configuration packet is correctly received.

In one embodiment, the advertising channel is configured based on a BLE protocol. The advertising channel also comprises a primary advertising channel and a secondary advertising channel. The broadcast receiving module is specifically configured for: searching for an extended advertising packet transmitted by the master device on the primary advertising channel; receiving a secondary advertising packet transmitted by the master device on the secondary advertising channel based on the extended advertising packet; and synchronizing and receiving the search packet based on the secondary advertising packet so as to synchronize with the master device.

In one embodiment, the configuration information comprises an access address scrambling code and/or a broadcast code. The audio receiving module is specifically configured for: obtaining the access address scrambling code and/or the broadcast code in the configuration information; obtaining an access address of the audio packet broadcast by the master device based on the access address scrambling code, and receiving the audio packet based on the access address; and/or decrypting the received audio packet using the broadcast code to obtain the playable audio data.

The more detailed function descriptions of the above various modules and units are the same as those of the corresponding embodiments above and will not be repeated here. A computer device having the audio multicasting device shown in FIG. 12 or the audio multicasting device shown in FIG. 13 is provided according to one embodiment of the present invention.

Refer to FIG. 14, which is a schematic structural diagram of a computer device provided according to one embodiment of the present invention. As shown in FIG. 14, the computer device comprises: one or more processors 10, a memory 20, and an interface for connecting various components, comprising high-speed interfaces and low-speed interfaces. Each component communicates and connects with different buses and can be installed on a common motherboard or installed in other ways as needed. The processor can process instructions executed in the computer device, comprising instructions stored in the memory or on the memory to display graphical information of the GUI on an external input/output device (such as a display device coupled to the interface). In one embodiment, if necessary, multiple processors and/or multiple buses can be used together with multiple memories and multiple memories. Similarly, multiple computer devices can be connected, and each device provides some necessary operations (for example, as a server array, a set of blade servers, or a multiprocessor system). In FIG. 14, one processor 10 is taken as an example.

The processor 10 can be a central processing unit, a network processor, or a combination thereof. The processor 10 can further comprise a hardware chip. The above hardware chip can be an application specific integrated circuit, a programmable logic device, or a combination thereof. The above programmable logic device can be a complex programmable logic device, a field programmable gate array, a general array logic, or any combination thereof. The memory 20 stores instructions executable by at least one processor 10, so that at least one processor 10 executes the method shown in the above embodiments.

The memory 20 may comprise a storage program area and a storage data area. The storage program area can store an operating system and application programs required by at least one function. The storage data area can store data created according to the use of a computer device for displaying the landing page of a small program. In addition, the memory 20 may comprise high-speed random access memory, and may also comprise non-transitory memory, such as at least one magnetic disk storage device, flash memory device, or other non-transitory solid-state storage device. In one embodiment, the memory 20 may optionally comprise a memory remotely set relative to the processor 10, and these remote memories can be connected to the computer device through a network. Examples of the above network include, but are not limited to, the Internet, an intranet, a local area network, a mobile communication network, and combinations thereof.

The memory 20 may comprise volatile memory, such as random access memory. The memory may also comprise non-volatile memory, such as flash memory, hard disk or solid state drive. The memory 20 may also comprise a combination of the above types of memories.

The computer device also comprises a communication interface 30 for the computer device to communicate with other devices or communication networks. Program code for implementing the methods of the present invention may be written in any combination of one or more programming languages. Such program code may be provided to a processor or controller of a general-purpose computer, a specialized computer, or other programmable data processing device such that the program code when executed by the processor or controller causes the functions/operations set forth in the flowchart and/or the block diagram to be implemented. The program code may be executed entirely on the machine, partially on the machine, partially on the machine as a stand-alone software package and partially on a remote machine or entirely on a remote machine or server.

In one embodiment, the present invention also provides a computer-readable storage medium having a computer program stored thereon. When the computer program is executed by a processor to realize the BLE broadcast communication method in the above-described embodiments and can achieve the same technical effect, which will not be repeated herein in order to avoid repetition. The computer-readable storage medium can be a read-only memory (ROM), random access memory (RAM), magnetic disc or optical disc, etc. . . .

The embodiments of this application are described above in conjunction with the accompanying drawings, but this application is not limited to the specific embodiments described above, the specific embodiments described above are merely illustrative and not limiting, and the person of ordinary skill in the field of this application, without departing from the purpose of the application and the scope of protection of the claims, may also make many forms, all of which are under the protection of this application.

Although preferred embodiments of the present invention have been described, additional changes and modifications to these embodiments may be made once the basic creative concepts are known to those skilled in the art. The appended claims are therefore intended to be interpreted to comprise preferred embodiments and all changes and modifications falling within the scope of this application. Obviously, a person skilled in the art may make various changes and variations to the application without departing from the spirit and scope of the application. Thus, if these modifications and variations of this application fall within the scope of the claims and their equivalent technologies, the application is also intended to comprise these changes and variations.

What is claimed is:

1. An audio multicasting method, applied to a master device, comprising:
broadcasting an audio packet based on a Broadcast Isochronous Group (BIG) link protocol;
performing a periodic broadcast based on an advertising channel including a periodic advertising channel; and
communicating bi-directionally with one or more slave devices on the periodic advertising channel based on a pre-configured bidirectional periodic advertising link protocol to allow one or more selected slave devices to group with the master device while performing the periodic broadcast, wherein the one or more selected slave devices are allowed to receive the audio packet and extract playable audio data from the received audio packet.

2. The audio multicasting method according to claim 1, wherein the communicating bi-directionally with one or more slave devices on the periodic advertising channel based on a pre-configured bidirectional periodic advertising link protocol to allow one or more selected slave devices to group with the master device, comprises:
broadcasting a search packet on the periodic advertising channel;
receiving a grouping request packet transmitted by one or more slave devices based on the search packet;
transmitting a configuration packet to the one or more selected slave devices based on a slave device information contained in the grouping request packet, the configuration packet comprising a configuration information for the one or more selected slave devices to receive the audio packet and extract the playable audio data from the received audio packet based on the configuration information; and
receiving a response packet transmitted by the one or more selected slave devices based on the configuration packet to complete grouping with the selected slave device.

3. The audio multicasting method according to claim 2, wherein the search packet carries a BIG link information and a master device address;
the grouping request packet carries the master device address, a slave device address, and a device identity information;
the configuration packet carries the master device address, a selected slave device address, the BIG link information, and a grouping configuration information; and
the response packet carries the master device address and the slave device address.

4. The audio multicasting method according to claim 2, wherein a time slot for transmitting the search packet and the configuration packet is a time slot for transmitting a synchronous packet specified by a BLE protocol,
a time slot for receiving the grouping request packet and the response packet is a time slot which is after the time slot for transmitting the synchronous packet specified by the BLE protocol and is spaced by a predetermined inter-packet interval time length.

5. The audio multicasting method according to claim 2, wherein the advertising channel is configured based on a BLE protocol, and the advertising channel further comprises a primary advertising channel and a secondary advertising channel.

6. The audio multicasting method according to claim 5, wherein the performing a periodic broadcast based on an advertising channel further comprises:
transmitting an extended advertising protocol packet on the primary advertising channel, and transmitting an auxiliary advertising protocol packet on the secondary advertising channel for the slave device to synchronize and receive the search packet.

7. An audio multicasting method, applied to a slave device, comprising:
receiving a periodic broadcast from a master device based on an advertising channel comprising a periodic advertising channel;
communicating bi-directionally with the master device on the periodic advertising channel based on a pre-configured bidirectional periodic advertising link protocol to be allowed by the master device to group with the master device as a selected slave device upon receiving the periodic broadcast; and
receiving an audio packet broadcast by the master device based on a BIG link protocol and extracting playable audio data from the received audio packet in the case of grouping with the master device as the selected slave device.

8. The audio multicasting method according to claim 7, wherein the communicating bi-directionally with the master device on the periodic advertising channel based on a pre-configured bidirectional periodic advertising link protocol to be allowed by the master device to group with the master device as a selected slave device upon, comprises:
receiving a search packet transmitted by the master device on the periodic advertising channel;
transmitting a grouping request packet to the master device based on the search packet;
receiving a configuration packet transmitted by the master device, the configuration packet comprising a configuration information for the selected slave device to receive the audio packet and extract the playable audio data from the received audio packet based on the configuration information; and
transmitting a response packet to the master device to complete grouping with the master device as the selected slave device when the configuration packet is correctly received.

9. The audio multicasting method according to claim 8, wherein the advertising channel is configured based on a BLE protocol, and the advertising channel further comprises a primary advertising channel and a secondary advertising channel.

10. The audio multicasting method according to claim 9, wherein the receiving a periodic broadcast from a master device based on an advertising channel further comprises:
searching for an extended advertising packet transmitted by the master device on the primary advertising channel;
receiving a secondary advertising packet transmitted by the master device on the secondary advertising channel based on the extended advertising packet; and
synchronizing and receiving the search packet based on the secondary advertising packet so as to synchronize with the master device.

11. The audio multicasting method according to claim 8, wherein the configuration information comprises an access address scrambling code and/or a broadcast code.

12. The audio multicasting method according to claim 11, wherein the receiving an audio packet broadcast by the master device based on a BIG link protocol and extracting playable audio data from the received audio packet, comprises:
obtaining the access address scrambling code and/or the broadcast code in the configuration information;
obtaining an access address of the audio packet broadcast by the master device based on the access address scrambling code, and receiving the audio packet based on the access address; and/or
decrypting the received audio packet using the broadcast code to obtain the playable audio data.

13. An audio multicasting device, applied to a master device, comprising:
an audio transmitting module for broadcasting an audio packet based on a BIG link protocol;
a periodic broadcast module for performing a periodic broadcast based on an advertising channel comprising a periodic advertising channel;
a first grouping module for communicating bi-directionally with one or more slave devices on the periodic advertising channel based on a pre-configured bidirectional periodic advertising link protocol to allow one or more selected slave devices to group with the master device while performing the periodic broadcast, wherein the one or more selected slave devices are the slave devices that are allowed to receive the audio packet and extract playable audio data from the received audio packet.

14. The audio multicasting device according to claim 13, wherein the first grouping module is configured for:
broadcasting a search packet on the periodic advertising channel;
receiving a grouping request packet transmitted by one or more slave devices based on the search packet;
transmitting a configuration packet to the one or more selected slave devices based on a slave device information contained in the grouping request packet, the configuration packet comprising a configuration information for the one or more selected slave devices to receive the audio packet and extract the playable audio data from the received audio packet based on the configuration information; and
receiving a response packet transmitted by the one or more selected slave devices based on the configuration packet to complete grouping with the selected slave device.

15. The audio multicasting device according to claim 14, wherein
the search packet carries a BIG link information and a master device address;
the grouping request packet carries the master device address, a slave device address, and a device identity information;
the configuration packet carries the master device address, a selected slave device address, the BIG link information, and a grouping configuration information; and
the response packet carries the master device address and the slave device address.

16. The audio multicasting device according to claim 15, wherein a time slot for transmitting the search packet and the configuration packet is a time slot for transmitting a synchronous packet specified by a BLE protocol,
a time slot for receiving the grouping request packet and the response packet is a time slot which is after the time slot for transmitting the synchronous packet specified by the BLE protocol and is spaced by a predetermined inter-packet interval time length.

17. The audio multicasting device according to claim 14, wherein the advertising channel is configured based on a BLE protocol, and the advertising channel further comprises a primary advertising channel and a secondary advertising channel,
the periodic broadcast module is configured for:
transmitting an extended advertising protocol packet on the primary advertising channel, and transmitting an auxiliary advertising protocol packet on the secondary advertising channel for the slave device to synchronize and receive the search packet.

18. An audio multicasting device, applied to a slave device, comprises:
a broadcast receiving module for receiving a periodic broadcast from a master device based on an advertising channel comprising a periodic advertising channel;
a second grouping module for communicating bi-directionally with the master device on the periodic advertising channel based on a pre-configured bidirectional periodic advertising link protocol to be allowed by the master device to group with the master device as a selected slave device upon receiving the periodic broadcast;
an audio receiving module for receiving an audio packet broadcast by the master device based on a BIG link protocol and extracting playable audio data from the received audio packet in the case of grouping with the master device as the selected slave device.

19. The audio multicasting device according to claim 18, wherein the second grouping module is configured for:
receiving a search packet transmitted by the master device on the periodic advertising channel;
transmitting a grouping request packet to the master device based on the search packet;
receiving a configuration packet transmitted by the master device, the configuration packet comprising a configuration information for the selected slave device to receive the audio packet and extract the playable audio data from the received audio packet based on the configuration information; and
transmitting a response packet to the master device to complete the grouping with the master device as the selected slave device when the configuration packet is correctly received.

20. The audio multicasting device according to claim 19, wherein the advertising channel is configured based on a BLE protocol, the advertising channel further comprises a primary advertising channel and a secondary advertising channel,
the broadcast receiving module is configured for:
searching for an extended advertising packet transmitted by the master device on the primary advertising channel;
receiving a secondary advertising packet transmitted by the master device on the secondary advertising channel based on the extended advertising packet; and
synchronizing and receiving the search packet based on the secondary advertising packet so as to synchronize with the master device.
